(19) United States
(12) Patent Application Publication
(10) Pub. No.: US 2026/0204236 A1
(43) Pub. Date: Jul. 16, 2026

(54) SCALABLE MIRROR DRIVER CIRCUITRY AND LIGHT PROTECTION FOR LIGHT MODULATOR

(71) Applicant: Texas Instruments Incorporated, Dallas, TX (US)

(72) Inventors: Brenda McWilliams, Dallas, TX (US); Harsh D. Jhaveri, Wylie, TX (US)

(21) Appl. No.: 19/444,469

(22) Filed: Jan. 9, 2026

Related U.S. Application Data
(60) Provisional application No. 63/743,866, filed on Jan. 10, 2025.

(51) Int. Cl. G09G 3/34; G02B 26/10; G09G 3/02; G02B 26/08; G02F 1/1362

(52) U.S. Cl. CPC G09G 3/346; G02B 26/101; G09G 3/025; G02B 26/0841; G02F 1/136209; G02F 1/136227; G09G 2300/0819; G09G 2300/0857; G09G 2310/0289; G09G 2310/0291; G09G 2330/028; G09G 2330/04

(57) ABSTRACT

In an example, a light modulator includes an array of pixel elements grouped into blocks and arranged with a minimum pixel pitch, and configurable between ON and OFF states; reset control circuitry coupled to the pixel elements and configurable to control the states of the pixel elements; and light-blocking apparatus configured to protect the reset control circuitry from stray carriers induced by incident light. The reset control circuitry may include: banks of pixel block drivers configurable to output reset voltages for individual blocks, each bank of pixel block drivers including a bank of reset capacitors and one or more reset drivers arranged according to the minimum pixel pitch; a signal bus coupled to the banks of pixel block drivers; and one or more supply voltage generators selectively couplable to the signal bus and configurable to generate a supply voltage for one or more of the banks of pixel block drivers.

### CROSS-REFERENCE TO RELATED APPLICATION

This application claims priority to U.S. Provisional Patent Application No. 63/743,866 titled “INCREASE SOLUTION SPACE HIGH VOLTAGE MIRROR DRIVERS WITH OPTIMIZED SCALABILITY FOR SMALLER PIXEL SIZES” filed on 10 January 2025, which is hereby incorporated herein by reference in its entirety.

### BACKGROUND

Light modulator devices, such as spatial light modulators and phase light modulators, are used in various technologies, including light projection and/or imaging systems. Some light modulator devices include an array of addressable pixels that can change the intensity and/or phase of an incident beam of light. Light modulator devices are used in, for example, high dynamic range cinema, low cost optical projection, light detection and ranging systems, high volume optical switching (e.g., used in telecom or server farms), microscopy, spectroscopy, adaptive optics, holographic displays, automotive projection (e.g. smart headlights, heads-up display (HUD), transparent window displays, interior lighting, and ground projection), near-eye displays, digital direct imaging, 3D printing, 3D-scanning, other projection displays, and other light control applications.

### SUMMARY

In one example, a light modulator comprises: a two-dimensional array of pixel elements grouped into blocks, individual blocks including one or more pixel elements of the array, the pixel elements arranged relative to one another in the array with at least a minimum pixel pitch and having operating states configurable between an ON state and an OFF state; and reset control circuitry coupled to the array of pixel elements and configurable to control the operating states of the pixel elements. The reset control circuitry includes: a plurality of banks of pixel block drivers configurable to output respective reset voltages for respective individual blocks, and each bank of pixel block drivers in the plurality of banks of pixel block drivers including a bank of reset capacitors and one or more reset drivers arranged according to the minimum pixel pitch; a signal bus coupled to the plurality of banks of pixel block drivers; and one or more supply voltage generators selectively couplable to the signal bus and configurable to generate a supply voltage for one or more of the banks of pixel block drivers. The light modulator further comprises a light-blocking apparatus configured to protect one or more elements of the reset control circuitry from stray carriers induced by light incident on the light modulator with an intensity above a threshold lumen level.

In another example, an integrated circuit comprises: a substrate; a two-dimensional array of memory cells on the substrate; a two-dimensional array of pixel elements positioned over the array of memory cells, each pixel element of the array of pixel elements electrically connected to an output of a respective memory cell of the array of memory cells; a plurality of metal layers arranged between the array of memory cells and the array of pixel elements; control circuitry including circuit elements formed in one or more metal layers of the plurality of metal layers, the circuit elements including at least one transistor and the control circuitry operably coupled to the array of memory cells; and a light-blocking apparatus. The light blocking apparatus includes: one or more guard rings formed in the one or more metal layers and at least partially surrounding a corresponding one or more respective circuit elements in the one or more metal layers; at least one isolation well coupled to the at least one transistor; and an isolation wall operable to block stray carriers from reaching the circuit elements, the stray carriers being induced by light incident on the integrated circuit with an intensity above a threshold lumen level.

In another example, a light modulator comprises: a substrate; a two-dimensional array of memory cells on the substrate; a two-dimensional array of pixel elements positioned over the array of memory cells, each pixel element of the array of pixel elements electrically connected to an output of a respective memory cell of the array of memory cells, the array of pixel elements arranged into a plurality of groups with each group including one or more pixel elements; and control circuitry coupled to the array of memory cells and to the array of pixel elements. The control circuitry includes: a data interface configurable to receive image data, the control circuitry configurable to write the image data to the array of memory cells to control operational states of the array of pixel elements; and adjustable reset control circuitry. The adjustable reset control circuitry includes: a plurality of banks of pixel block drivers configurable to provide respective control voltages to respective individual groups and each bank of pixel block drivers in the plurality of banks of pixel block drivers including a bank of reset capacitors and an adjustable number of one or more reset drivers; a signal bus coupled to the plurality of banks of pixel block drivers; adjustable number of supply voltage generators selectively coupled to the signal bus and configurable to provide a supply voltage to the signal bus; a plurality of level shifters coupled between the signal bus and the plurality of banks of pixel block drivers, individual level shifters configurable to adjust a voltage level of the supply voltage supplied to a respective one of the plurality of banks of pixel block drivers; and a plurality of buffers coupled between the plurality of level shifters and the plurality of banks of pixel block drivers.

### BRIEF DESCRIPTION OF THE DRAWINGS

FIG. 1 is a block diagram of a light projection system, in an example.

FIG. 2 is an exploded oblique view of a block diagram of a portion of a light modulator device, in an example.

FIG. 3A is a diagram of a pixel of the light modulator of FIG. 2, in an example.

FIG. 3B is an overlay view showing an alignment, relative to a memory layer, of a micromirror portion of pixels formed in a mirror layer of the light modulator of FIG. 2, in an example.

FIG. 4 is a block diagram of the light modulator of FIGS. 2-3B, in an example.

FIG. 5 is a block diagram showing an adjustable bank of MBRST drivers of the light modulator of FIG. 4, in an example.

FIG. 6 is a flow diagram of a method of configuring the adjustable reset control circuitry of the light modulator of FIG. 4, in an example.

FIG. 7 is a circuit diagram of a voltage generator as may be used in the light modulator of FIG. 4, in an example.

FIG. 8A is a block diagram showing the light modulator of FIG. 4 including a light-blocking apparatus, in an example.

FIG. 8B is a block diagram representing a cross-sectional view of a portion of the light-blocking apparatus of FIG. 8A, in an example.

FIG. 9A is a diagram representing a top view of a portion of an isolation wall of the light-blocking apparatus of FIGS. 8A and 8B, in an example.

FIG. 9B is a diagram representing a cross-section view of the portion of the isolation wall of FIG. 9A, in an example.

FIG. 10 is a diagram illustrating a representation of a portion of the light-blocking apparatus of FIGS. 8A and 8B, in an example.

The same reference numbers or other reference designators are used in the drawings to designate the same or similar (functionally and/or structurally) features. The figures are not necessarily drawn to scale.

### DETAILED DESCRIPTION

Described herein are techniques for improving scalability and performance in spatial light modulator devices that have micromechanical electrostatic pixels capable of modulating an incident beam of light (e.g., in terms of phase or intensity). Certain examples provide a driver circuitry architecture that allows ease of scaling as well as open solution space (e.g., to accommodate larger voltage ranges, lower operating power, and/or reduced die area as may be needed for light modulators using relatively smaller pixel sizes), and which may include light blocking mechanisms to protect against optical issues. In one example, a light modulator comprises a two-dimensional array of pixel elements grouped into blocks, with individual blocks including one or more pixel elements of the array, wherein the pixel elements are arranged relative to one another in the array with at least a minimum pixel pitch and have operating states configurable between an ON state and an OFF state. In the example, the light modulator includes reset control circuitry coupled to the array of pixel elements and configurable to control the operating states of the pixel elements. The reset control circuitry may include a plurality of banks of pixel block drivers configurable to output respective reset voltages for respective individual blocks, wherein each bank of pixel block drivers in the plurality of banks of pixel block drivers includes a bank of reset capacitors and one or more reset drivers arranged according to the minimum pixel pitch. The reset control circuitry may further include a signal bus coupled to the plurality of banks of pixel block drivers, and one or more supply voltage generators selectively couplable to the signal bus and configurable to generate a supply voltage for one or more of the banks of pixel block drivers. In the example, the light modulator further comprises a light-blocking apparatus configured to protect one or more elements of the reset control circuitry from stray carriers induced by light incident on the light modulator with an intensity above a threshold lumen level.

These and other aspects are described in more detail below.

### General Overview

Light modulators may employ an array of pixels that can be controlled (e.g., individually and/or in groups or blocks) to modulate incident light to project images. There are various applications in which providing arrays with smaller pixel sizes may offer advantages, such as smaller size of the light modulator and/or increased resolution in the projected images. Small pixel testing and development may involve providing a larger voltage range, along with lower operating power and area reduction, relative to light modulators that employ larger pixel sizes. In addition, as the pixel sizes become smaller, the driver circuitry associated with the pixels may also become smaller and/or more densely packed on the circuit board. As a result, the circuitry may be more susceptible to errors or other issues caused by stray light-induced carriers (e.g., from the incident light used to illuminate the pixels to project images).

Accordingly, to address these and other issues, techniques are described herein for providing control circuitry for light modulators, including pixel block drivers, voltage generators, and/or other control circuitry components, that is adaptable to light modulators with small pixel sizes and scalable for different array sizes. Examples further include a light-blocking apparatus, including an isolation wall, isolation wells, and/or guard rings formed in various layers of the circuit board on which the driver circuitry is implemented, to protect sensitive circuit components from light-induced carriers that could otherwise disrupt proper operation of the circuitry. In one example, an integrated circuit comprises a substrate, a two-dimensional array of memory cells on the substrate, and a two-dimensional array of pixel elements positioned over the array of memory calls, wherein each pixel element of the array of pixel elements is electrically connected to an output of respective memory cell of the array of the memory cells. In the example, the integrated circuit further comprises a plurality of metal layers arranged between the array of memory cells and the array of pixel elements, and control circuitry including circuit elements formed in one or more metal layers of the plurality of metal layers, the circuit elements including at least one transistor and the control circuitry operably coupled to the array of memory cells. The integrated circuit may further include a light-blocking apparatus that includes one or more guard rings formed in the one or more metal layers and at least surrounding a corresponding one of more respective circuit elements in the one or more metal layers, at least one isolation well coupled to at least one transistor, and an isolation well operable to block stray carriers from reaching the circuit elements, the stray carriers being induced by light incident on the integrated circuit with an intensity above a threshold lumen level. Further examples provide light modulators including the integrated circuit, and methods for producing and/or operating circuitry included in the integrated circuit and/or light modulators.

### Example System Architecture

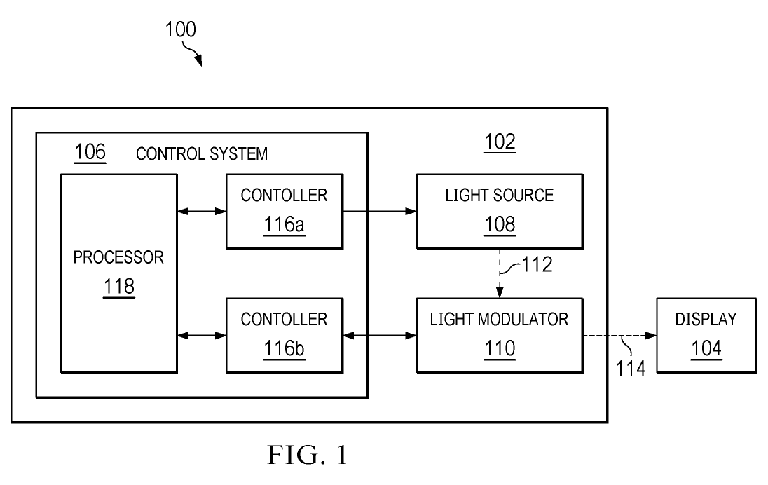

FIG. 1 is a block diagram illustrating a system 100 including a light projection system 102 coupled to a display 104, according to an example. The light projection system 102 includes a control system 106, a light source 108, and a light modulator 110. The light source 108 may produce illumination light 112 that is directed to the light modulator 110. The light modulator may modulate the illumination light 112 to project an image 114 to the display 104. In some examples, the illumination light 112 from the light source includes multiple colors (e.g., red, green, and blue). The multiple colors can be transmitted to the light modulator 110 concurrently or by time-multiplexing multiple emitters of different colors in the light source 108.

The light modulator 110 can be a microelectromechanical system (MEMS) based spatial light modulator (SLM), such as a digital mirror device (DMD), or a liquid crystal-based SLM, such as a liquid crystal display (LCD) or liquid crystal on silicon (LCoS) device. The light modulator 110 modulates the intensity of the illumination light 112 based on optical elements that are controlled to manipulate the light and accordingly form the pixels of a displayed image. In some examples, the light modulator 110 is a DMD wherein the optical elements are adjustable tilting micromirrors that are tilted by applying voltages to the micromirrors through respective electrodes. The micromirrors are tilted to project dark pixels or bright pixels with color shades. As such, the light modulator 110 may be employed as a DMD-based optical switch configurable to selectively direct light in different directions. In other examples, the light modulator 110 is an LCD or an LCoS device, where the optical elements are liquid crystals that are controlled by voltage to modulate the intensity of light across the image pixels. The intensity of light is modulated by applying voltage to the liquid crystals, which reorients the crystals, also referred to herein as switching the crystals, and accordingly controls the amount of light projected per pixel. The optical elements can be a transmissive array of liquid crystal cells such as in an LCD, or a reflective array of liquid crystal cells such as in an LCoS device. The cells of liquid crystals can be controlled by voltages, through respective electrodes, to modulate light.

In other examples, the light modulator 110 can be a phase light modulator (PLM) or a ferroelectric liquid crystal on silicon (FLCoS) device. A PLM can be a MEMS device including micromirrors that have adjustable heights with respect to the PLM surface. The heights of the micromirrors can be adjusted by applying voltages. The micromirrors may be controlled with different voltages to form a diffraction surface on the PLM. For example, each micromirror can be coupled to respective electrodes for applying a voltage and controlling the micromirror independently from the other micromirrors of the PLM. The diffraction surface is a phase altering reflective surface to light incident on the surface of the light modulator 110 from the light source 108. The phase altering reflective surface represents a hologram for projecting illumination patterns of light that form the image 114 at the display 104. The hologram is formed as a diffraction surface by adjusting the heights of the micromirrors of the PLM.

In some examples, the control system 106 includes one or more controllers 116 configured to control the light modulator 110 and the light source 108 to display the images or video. For example, the control system 106 may include a first controller 116a for controlling the light source 108 to transmit the illumination light 112, and a second controller 116b for controlling the light modulator 110 to modulate the incident illumination light 112 from the light source 108. In some examples, the first and second controllers 1116a, 116b may be a single controller. The control system 106 may also include a processor 118 configured to process image data and direct operation of the controllers 116a, 116b based on the processed image data to produce the image 114 for display. In some examples, the processor 118 may control synchronization between the first controller 116a and the second controller 116b.

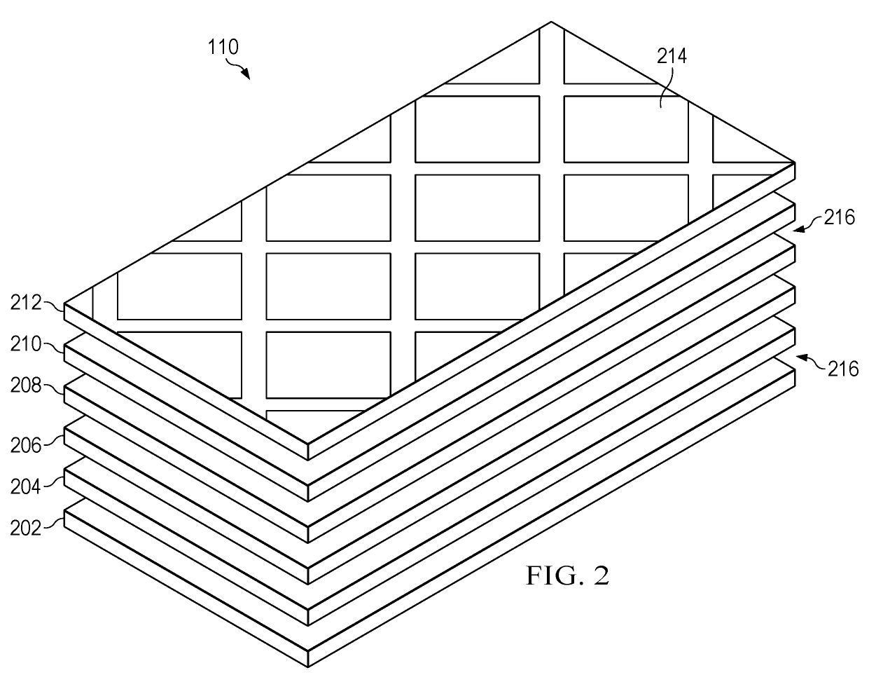

Referring to FIG. 2, there is illustrated an exploded oblique view of a portion of the light modulator 110, according to an example. In this example, the light modulator 110 includes a substrate 202, a memory layer 204 on the substrate 202, one or more first metal layers 206 on the memory layer 204, one or more second metal layers 208 on the first metal layer 206, a hinge layer 210 on the second metal layer(s) 208, and a mirror layer 212 on the hinge layer 214. Thus, in the illustrated example, the light modulator 110 is a DMD including a plurality of micromirrors formed in the mirror layer 212 and coupled to circuitry formed in other layers via the hinge layer 210, as described further below. The light modulator 110 includes an array of pixels 214 formed in at least some of the layers 204-212. The substrate 202 and the various layers 204-212 may be physically separated and/or at least partially electrically isolated from one another by gap layers 216, which may include a dielectric or non-conducting material. For example, the memory layer 204 and the plurality of overlying metal layers 206, 208 may each be encapsulated within nonconductive material (e.g., an oxide; not explicitly shown) formed on substrate 202. In other examples, the light modulator 110 may include additional layers not explicitly shown in FIG. 2 (e.g., additional first metal layers 206, additional second metal layers 208, and/or other additional layers). Further, any of the layers 204-210 may include multiple sub-layers. Conductive (e.g., metal) vias (not shown in FIG. 2) can be formed in the layered structure of the light modulator 110, extending vertically between two or more layers or sub-layers, to provide electrical interconnection between layers and/or sub-layers.

According to certain examples, the array of pixels 214 may include thousands or even millions of individually controllable pixels 214. Each pixel 214 can selectively modulate the illumination light 112 (e.g., in terms of phase, intensity, or angle of transmission) depending on electrical signals applied to the pixel 214, thereby producing the projected image 114, as described above. In examples in which the light modulator 110 is a DMD, each pixel 214 may include a memory cell and a micromirror that is tiltable between an OFF state position and an ON state position based on image data loaded to the memory cells 302 from the controller 116b, for example.

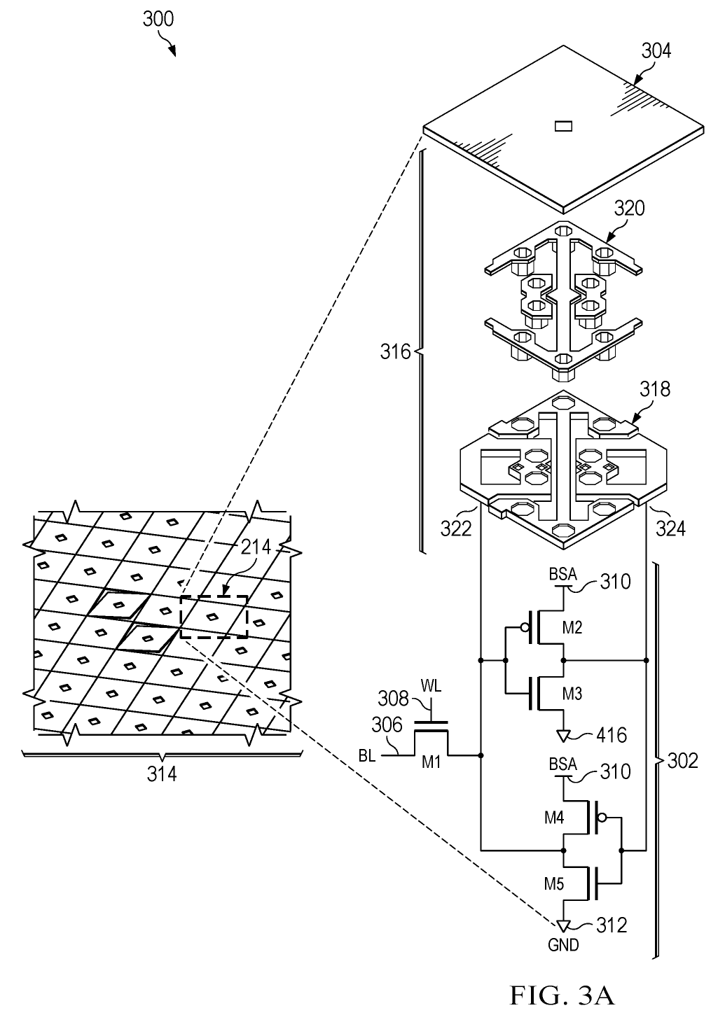

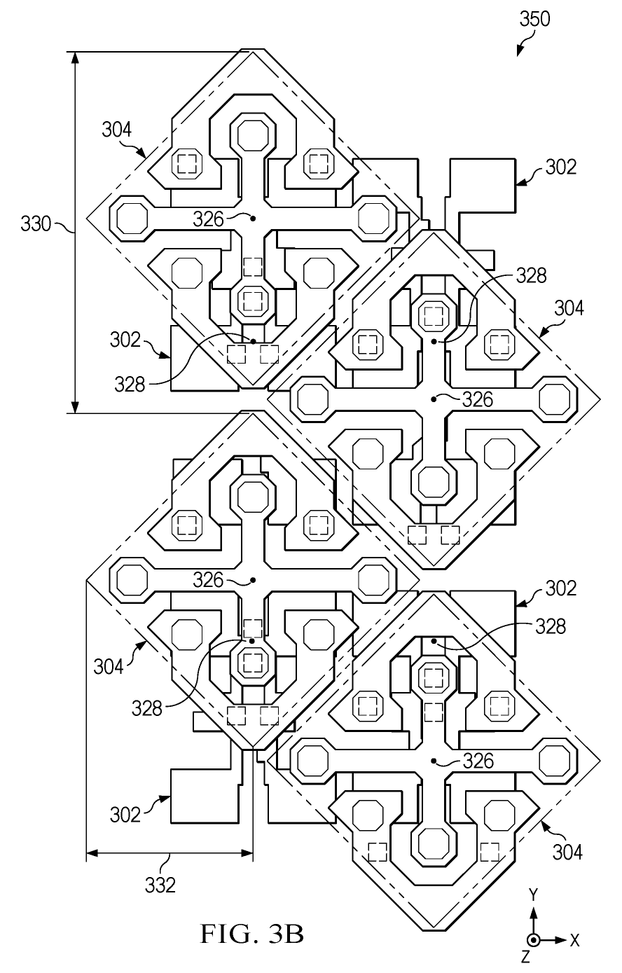

FIG. 3A is a diagram 300 illustrating a portion of a mirror array 314, showing a partial exploded view and circuit schematic of a pixel 214 in the mirror array 314. As shown in FIG. 3A, the pixel 214 includes a memory cell 302 coupled to a light modulation element 316. The light modulation element 316 includes the micromirror 304. In some examples, the light modulation element 316 may also be referred to as a pixel element 316. The memory cell 302 may be formed (partially or entirely) in the memory layer 204. Thus, the memory layer 204 may include a matrix of the memory cells 302 fabricated in an integrated circuit, in which address decoding in the circuit allows access to each memory cell 302 for read/write functions. Such a matrix of memory cells 302 may collectively form static random access memory (SRAM). Some SRAM memory cells 302 use active feedback from cross-coupled inverters in the form of a latch to store or “latch” a bit of information. The SRAM memory cells 302 can be arranged in rows or columns, which can facilitate simultaneously reading or writing blocks of data such as words or bytes. In some examples, there is a one-to-one ratio between a number of memory cells 302 in the mirror array 314 and a number of light modulation elements 316, such that each light modulation element 316 has one corresponding, dedicated memory cell 302 in the pixel 214.

Continuing with the example of FIGS. 2 and 3A, the metal layers 206, 208 may include conductive patterns that can be used to route electrical signals to and from adjacent layers (e.g., memory layer 204, other metal layers, and/or the hinge layer 210), and which may form part of the circuitry associated with the mirror array 314 of pixels 214. For example, the electrical signals may be transmitted by respective conductive patterns within the metal layers 206, 208 associated with various bit lines, a word-line, a block step address (BSA) power supply, or a source power supply (Vss) (e.g., ground). The hinge layer 210 may include multiple conductive patterns that can be used to route electrical signals to and from adjacent layers (e.g., any of the metal layers 206, 208 and/or the mirror layer 212). For example, the hinge layer 210 may include hinge posts physically and electrically coupling the hinge layer 210 to at least one of the metal layers 208. The hinge layer 210 may also include rotationally symmetric patterns that can be used to form certain pixel superstructures. For example, hinge layer 210 may contain the torsional hinges, spring tips, and/or other components that interoperate to enable controlled mechanical motion of the micromirror 304 of a respective pixel 214 based on the image data loaded to its respective memory cell 302. The mirror layer 212 may include rotationally symmetric patterns that can be used to form the micromirrors 304 for the pixels 214, as described further below.

In some examples, the light modulation element 316 includes the micromirror 304, an electrode layer 318, and a MEMS hinge element 320. As described above, the hinge element 320 may be formed (partially or entirely) in the hinge layer 210. The electrode layer 318 may be formed in one or more of the metal layers 206, 208. In the illustrated example, the electrode layer 318 has a first terminal 322 and a second terminal 324. In the example of FIG. 3A, the electrode layer 318, the MEMS hinge element 320, and the mirror 304 are shown in an exploded view. When assembled, the electrode layer 318, the MEMS hinge element 320, and the mirror 304 enable the mirror 320 to maintain two or more positions (e.g., an ON position and an OFF position) responsive to control signals from the memory cell 302. In different examples, the size, the layout, the ON/OFF positions of the electrode layer 318, the MEMS hinge element 320, and/or the mirror 304 may vary.

Referring to FIG. 3A, in some examples, the memory cell 302 includes a plurality of transistors M1 – M5 connected in the arrangement shown (or a variation thereof). Each of the transistors M1 – M5 has a first terminal, a second terminal, and a control terminal. In the example of FIG. 3A, the transistors M1, M3, and M5 are n-channel field-effect semiconductor (NMOS) transistors, and the transistors M2 and M4 are p-channel field-effect semiconductor (PMOS) transistors. However, in other examples, other transistor types can be used.

Continuing with the example of FIG. 3A, the first terminal of the transistor M1 is coupled to a bit line (BL) terminal 306, and the second terminal of the transistor M1 is coupled to the control terminals of the transistors M2 and M3, the second terminal of the transistor M4, the first terminal of the transistor M5, and the first terminal 322 of the electrode layer 318. The control terminal of the transistor M1 is coupled to a word line (WL) terminal 308. The first terminal of the transistor M2 is coupled to a BSA power supply terminal 310. The second terminal of the transistor M2 is coupled to the first terminal of the transistor M3, the control terminals of the transistors M4 and M5, and the second terminal 324 of the electrode layer 316. The second terminal of the transistor M3 is coupled to a ground terminal 312. The first terminal of the transistor M4 is coupled to the BSA power supply terminal 310. The second terminal of the transistor M5 is coupled to the ground terminal 312. In some examples, the memory cell 302 is configured to: receive a BL voltage at the BL terminal 306; receive a WL voltage at the WL terminal 308; receive a BSA voltage at the BSA power supply terminal 310; and provide control voltages at the first terminal 322 and the second terminal 324 of the electrode layer 316 responsive to the BL voltage, the WL voltage, and the BSA voltage. In one example, for a pixel ON state of the light modulator element 316, BL is set to 1, and WL is enabled. For a pixel OFF state of the light modulator element 316, BL is set to 0, and WL is enabled. As needed, a reset operation can be performed using a mirror bias reset (MBRST) voltage and BSA voltage, as described further below.

According to certain examples, the light modulation elements 316 can be arranged in a diamond pattern relative to the peripheral edges of the mirror array 314. Using a diamond pattern arrangement may facilitate achieving higher pixel density. Furthermore, in some examples, the diamond pattern of light modulation elements 316 may be orientated at an angle relative to a grid pattern of the array of underlying memory cells 302 in the memory layer 204, in which the grid pattern arranges the memory cells 302 in orthogonal rows and columns.

FIG. 3B is an overlay view 350 of a portion of the mirror array 314 showing a 2 X 2 subarray of pixels 214, and showing an alignment of the mirrors 304 relative to the memory cells 302, according to an example. As shown in FIG. 3B, in this example, each mirror 304 of the 2 X 2 subarray of pixels 214 overlaps respective portions of at least two adjacent memory cells 302. In some examples, the center of each light modulation element 316 is positionally offset from the center of its corresponding underlying memory cell 302, such that the respective centers are not perfectly aligned to one another. In instances where the outermost boundary of a feature of a pixel 214 (e.g., its micromirror 304) is not rotationally symmetric, the “center” of the pixel 214 as used herein refers to the intersection of the two lines bisecting the width and length of the smallest rectangle that can be drawn that completely frames the pixel 214. In instances where a pixel 214 is rotationally symmetric in terms of its micromirror 304, the “center” of the pixel 214 is defined herein as being the rotational center. In the example shown in FIG. 3B, the micromirrors 304 each have a rotational center 326 that is the middle point of the square micromirror 304.

According to certain examples, the rotational centers 326 of the micromirrors 304 are offset relative to centers 328 of the corresponding respective memory cells 302. In some examples, the offset directions are staggered from pixel to pixel, such that adjacent pixels along a diagonal (i.e., adjacent pixels 214 having sides opposing one another) will have differing respective offsets (between their micromirror 304 and memory cell 302. The use of varying offset between adjacent micromirrors 304 and respective memory cells 302, as shown by way of example in FIG. 3B, may facilitate the accommodation of a smaller row or column pitches for an array of pixels and hence a higher pixel density for the light modulator 110, while allowing sufficient space for the memory cells 302 to accommodate high-voltage transistors M1-M5. In addition, the use of varying offsets from pixel to pixel may optimize the use of a diamond pattern for the light modulation elements 316 relative to an underlying grid pattern for the memory cells 302, as described above. In some examples, the pixels 214 are arranged with a row pitch 330 (e.g., measuring the vertical distance between like features of adjacent pixels 214) and a column pitch 332 (e.g., measuring the horizontal distance between like features of adjacent pixels 214). In some examples, the row pitch 330 may be in a range of 6.0 to 8.0 micrometers (µm), for example, 6.4µm, and the column pitch 332 may be in a range of 3.0 to 4.5µm, for example, 3.2µm. However, in other examples, other row pitch and/or column pitch values can be used.

Further examples of pixel structures and arrangements that can be used for the pixels 214 and in the light modulator 110 are described in U.S. Patent Publication No. 2025/0329696 filed on April 20, 2024 and titled “DIAMOND PIXEL ARRAY WITH OFFSET MEMORY,” which is incorporated herein by reference in its entirety.

As described above, in some instances, it may be desirable to make the pixels 214 relatively smaller, thus increasing the pixel density over a given surface area in the light modulator 110. Increasing the pixel density (or decreasing the pixel size) may involve decreasing the pixel pitch, where “pixel pitch” in this context refers to the distance between like features of adjacent pixels 214, as described above. However, decreasing pixel pitch and/or pixel size can present certain design challenges. For example, the transistors M1 – M5 of the memory cell 302 may support both lower-voltage and higher-voltage operations (e.g., to the tilt the micromirror 304 to ON state and OFF state positions). Semiconductor processing techniques associated with the fabrication of such transistors may impose certain design constraints, including the surface area accommodated by the transistors M1 – M5 and associated signal routing pathways. In some examples, using a diamond array pattern for the light modulation elements 316 in combination with varying offsets between the light modulation elements 316 and memory cells 302 of respective pixels 214 may facilitate accommodating smaller pixel pitches while providing sufficient space for the circuitry of the memory cells 302. However, this configuration, and smaller pixel sizes, may introduce other design challenges.

For example, the angle(s) of incidence of the illumination light 112 may be different for a diamond arrangement of micromirrors 304 than for a grid arrangement of micromirrors. In addition, smaller and/or more densely packed circuitry may be less robust and more susceptible to glitches or other errors that can be introduced by voltage variations and/or light-induced stray carriers. Furthermore, small pixel pitch (e.g., approximately 4.5 µm or similar) in the diamond arrangement may pose challenges in routing for reset circuitry voltage lines. In some examples, in addition to making the pixels 214 smaller, it may be desirable to operate the pixels with faster control timing and slew rates (e.g., to allow the micromirrors 304 to change position between the ON state and the OFF state more quickly). In some instances, to accommodate faster timing and slew rates, certain lines (e.g., those carrying the MBRST voltages and/or those connecting reset driver circuits to the memory cells 302) may be made thicker to reduce the risk of electromigration that could negatively impact the performance reliability of the circuitry. Using thicker lines may increase the capacitance per pixel 214. Furthermore, in some applications, it may be desirable to reduce power consumption in the light modulator 110.

To address these and other challenges, examples provide control circuitry for the mirror array 314 (e.g., voltage regulation circuitry, driver circuitry etc.) that is adjustable to meet different voltage and/or current demand levels among different implementations or examples of the light modulator 110 and scalable to be compatible with different mirror array sizes. In some examples, the control circuitry can be designed to support a wide pixel solution space (e.g., available voltage and/or current levels and supported timing), with one or more of the metal layers 206, 208 including optional connections to support adjustments to optimize (or improve) performance based on testing for a particular mirror array 314, as described further below. In addition, certain examples described herein provide techniques for light protection of sensitive circuitry, such as level shifters and/or voltage generators, to avoid glitches, particularly on higher-voltage power supply lines, such as the BSA voltage lines.

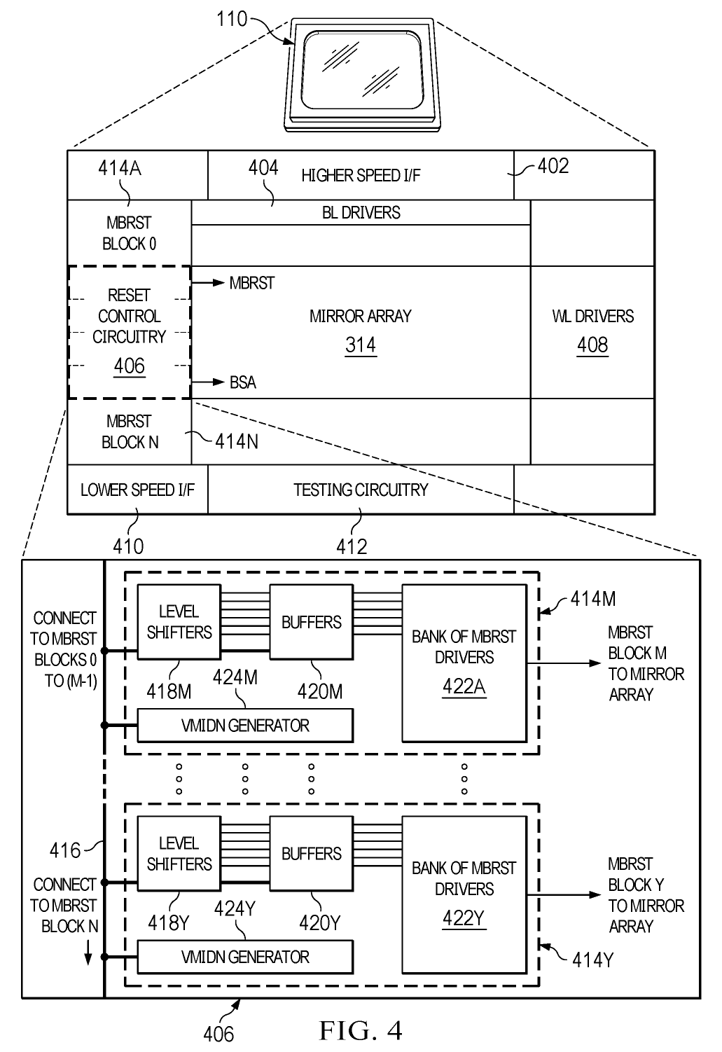

FIG. 4 is a diagram of the light modulator 110 in accordance with various examples. The light modulator 110 includes control circuitry and the mirror array 314. In the example of FIG. 4, the control circuitry includes a higher-speed interface (I/F) 402, bit line (BL) drivers 404, adjustable reset control circuitry 406, word line (WL) drivers 408, and a lower-speed interface 410. The control circuitry may further include testing circuitry 412. In some examples, the control circuitry is configurable to supply a number of different voltages to various components of the light modulator 110. Thes voltages may include a mirror bias reset (MBRST) voltage and related voltage levels, an internal power supply voltage (VMIDN), a block stepped address (BSA) voltage and related voltage levels, a word line (WL) voltage, and/or a bit line (BL) voltage. As used herein, the MBRST voltage is a reset voltage applied to pixel element control circuitry (e.g., part of a pixel array element). As used herein, VMIDN is a supply voltage used to power certain control circuitry of a light modulator (e.g., the adjustable reset control circuitry 406). As used herein, the BSA voltage is a supply voltage used to power the memory cells 302. As used herein, a WL voltage refers to the row write voltage for a pixel 214. Accordingly, a respective WL driver 408 may be coupled to respective WL terminal 308. As used herein, a BL voltage refers to the column write voltage for a pixel 214. Accordingly, a respective BL driver 404 may be coupled to a respective BL terminal 306. For example, the WL and BL voltages may be used to write a 1 or 0 to a memory cell 302 if the row is enabled. As described further below, the adjustable reset control circuitry 406 may be configurable based on information obtained using the testing circuitry 412 to adjust the VMIDN voltage and/or current, as described further below.

In some examples, the higher-speed interface 402 may be used for data transfers to provide the data to control bit lines and word lines to write data in respective memory cells 302. For example, the higher-speed interface 402 receives bitplane data (e.g., 1s and 0s for ON/OFF control of the pixels 214 of the mirror array 314). As described above, in some examples, the pixels 214 of the mirror array 314 include respective memory cells 302, where the ON/OFF state of each pixel 214 is controlled based on the bitplane data provided to the memory cell 302. In some examples, bitplane data indicating an ON state for a given pixel 214 of the mirror array 314 causes: a respective BL driver of the BL drivers 404 to be set to 1; a respective WL driver of the WL drivers 408 to be enabled; and respective components of the adjustable reset control circuitry 406 to set the MBRST and BSA voltages for the pixel ON state. In contrast, bitplane data indicating an OFF state for a given pixel 214 of the mirror array 314 causes: a respective BL driver of the BL drivers 404 to be set to 0; a respective WL driver of the WL drivers 408 to be enabled; and respective components of the adjustable reset control circuitry 406 to set the MBRST and BSA voltages for the pixel OFF state. In some examples, commands or configuration data received via the lower-speed interface 410 may be used to adjust the MBRST and BSA voltage levels. The BSA voltage may be applied to the BSA power supply terminals 310 of the pixels 214.

Continuing with the example of FIG. 4, the adjustable reset control circuitry 406 includes a plurality (e.g., N, where N is an integer greater than 1) of reset blocks 414. In the example of FIG. 4, reset blocks 414A (e.g., a first MBRST block 0) and 414N (e.g., a last MBRST block) are shown in block form, with a partial exploded view of a portion of the adjustable reset control circuitry 406 showing reset blocks 414M and 414Y. Reset blocks 414M and 414Y may be positioned and/or connected between reset blocks 414A and 414N, with any number of reset blocks 414 positioned and/or connected between reset blocks 414A and 414M, between reset blocks 414M and 414Y, and between reset blocks 414Y and 414N. The total number of reset blocks 414 may depend on the size of the mirror array 314, for example. The plurality of reset blocks 414 are coupled to a signal bus 416. Individual reset blocks 414 may include a set of level shifters 418 (with level shifters 418M and 418Y shown for reset blocks 414M and 414Y, respectively), a set of buffers 420 (with buffers 420M and 420Y illustrated for reset blocks 414M and 414Y, respectively), and a bank of MBRST drivers 422 (with banks of MBRST drivers 422M and 422Y shown for reset blocks 414M and 414Y, respectively. At least some reset blocks 414 may further include an optional voltage generator (e.g., a VMIDN generator) 424 (with VMIDN generators 424M and 424Y shown for reset blocks 414M and 414Y, respectively). In an example, the signal bus 416 is a common line for all reset blocks 414 to receive the VMIDN voltage. Each of the set of level shifters 418 is configured to shift the voltage levels relative to the VMIDN voltage level. Each of the sets of buffers 420 is configured to provide buffered voltages to a respective bank of MBRST drivers 422. Each of the VMIDN generators 424 is configurable to provide current to the bus 416 Each of the banks of MBRST drivers 422 is configurable to output a respective MBRST voltage responsive to bitplane data and/or other control data.

According to certain examples, in order to save design time and optimize (e.g., maximize) area efficiency, the adjustable reset control circuitry 406 can be configured to be scalable for various different row sizes of the mirror array 314 and for different supply current demands (e.g., drawn from the VMIDN generators 424) without the need for extensive circuit layout redesign. As described above, in some examples, due to the pixels 214 being relatively smaller, their circuitry (e.g., the circuitry of the memory cell 302) may be more sensitive to being perturbed by voltage variations. Accordingly, in some examples, components of the reset control circuitry 406 can be configured to provide improved performance across voltage and/or temperature variations.

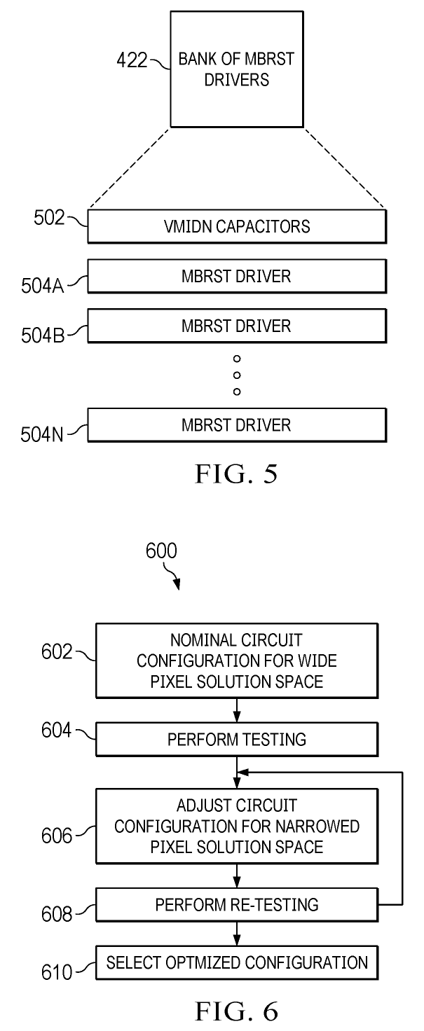

Referring to FIG. 5, there is illustrated a block diagram of a bank of MBRST drivers 422, according to an example. In this example, the bank of MBRST drivers 422 includes a bank of VMIDN capacitors 502, and a plurality (e.g., N, with N being an integer greater than or equal to one) of MBRST drivers 504 (individually labeled 504A, 504B, and 504N in FIG. 5). In some examples, the circuit layout of the plurality of MBRST drivers 504 can be designed to a selected pixel row pitch 330 that is compatible with standard row addressing schemes. The block size may be a certain number of pixels 214 (e.g., 8 pixels) times the pixel row pitch 330. In some examples, the bank of VMIDN capacitors 502 can be designed to the same selected pixel row pitch 330 as are the MBRST drivers 504. Thus, the MBRST drivers 504 and the bank of VMIDN capacitors 502 may be modular and can be interchanged based on design specifications or needs for a particular implementation of the light modulator 110. Furthermore, in some examples, supporting circuitry for the bank of MBRST drivers 422, such as the set of level shifters 418 and the set of buffers 420 can be placed before the bank of MBRST drivers (e.g., connected and arranged between the signal bus 416 and the respective bank of MBRST drivers 422, as shown in FIG. 4) and designed to fit within a minimum row height based on the reset block size. Thus, for example, the selected pixel row pitch 330 may be based on a minimum expected pixel size, such as a 4.5 µm diamond pixel pitch, as described above. The circuitry of each reset block 414 may then be designed to fit in a space defined by a minimum block size and the selected pixel row pitch 330. Accordingly, the reset block circuitry may be reused among multiple light modulator designs with the same or larger block size and/or pixel pitch. This modular approach may simplify reuse of circuitry among light modulators 110 with different mirror array sizes, providing time and/or cost savings in the design and/or fabrication processes for light modulators 110.

As described above, respective reset blocks 414 may optionally include the respective VMIDN generator 424. For different types/sizes of light modulators 110, the number of VMIDN generators 424 needed to support functionality may vary. Accordingly, in some examples, the number of VMIDN generators 424 used in any particular implementation of the adjustable reset control circuitry 406 can be determined based on the supply current needs of the particular mirror array 314. One way to reduce current is to reduce the number of functional VMIDN generators 424 included in the adjustable reset control circuitry 406. Reducing the number of functional VMIDN generators 424 to (or close to) a minimum number needed to supply the minimum (or close to minimum) current to support proper functioning of the light modulator 110 may reduce the power consumption of the light modulator 110, and may save die area and/or cost associated with the circuitry. Thus, individual reset blocks 414 may include the VMIDN generator 424 or not. Another way to reduce current provided by a set of VMIDN generators 424 is to selectively disable certain VMIDN generators 424. Thus, in some examples, VMIDN generators 424 may in included in some or all reset blocks 414, but may be selectively coupled to the signal bus 416 as needed. Accordingly, in some instances, VMIDN generators 424 may be distributed across reset blocks 414 in a configurable manner, either by selectively populating VMIDN generators 424 into selected reset blocks 414 during fabrication of the light modulator 110, or by selectively coupling certain VMIDN generators 424 to the signal bus 416. In some examples, an output current supplied from the VMIDN generators 424 to the signal bus 416 is also adjustable.

According to certain examples, testing can be performed to determine minimum current and/or voltage needed to support functionality of the light modulator 110, and thus to determine the number of functional VMIDN generators 424 to be used for a particular implementation. In some examples, testing involves a test interface and control signals to adjust the power levels provided components of the adjustable reset control circuitry 406, as described further below. In some examples, the testing circuitry 412 may facilitate testing of the adjustable reset control circuitry 406 to determine optimized parameters, such as the minimum number of functional VMIDN generators 424 to be used and/or particular voltage and/or current levels to be supplied by components of the adjustable reset control circuitry 406. For example, the testing circuitry 412 may include switches that allow selective coupling of the VMIDN generators 424 to the signal bus 416. In some examples, the testing circuitry 412 may include optional electrical (e.g., metal) interconnects formed in one or more of the metal layers 206, 208 that allow selective coupling of the VMIDN generators 424 to the signal bus 416. With this arrangement, the number of VMIDN generators 424 used to maintain pixel performance may be selected to reduce power consumption, with the selection being achievable with low-cost metal only revisions. As used herein, “metal only revisions” or “metal layer revisions” refer to a fabrication or testing process to minimally modify a design (e.g., the number of functional VMIDN generators 424 coupled to the signal bus 416) by adjusting one or metal layers 206, 208 without changing other aspects of the design. For example, selective disabling of select VMIDN generators 424 may be based on metal layer revisions (e.g., in one or more of the metal layers 206, 208). With metal layer revisions, any number of VMIDN generators 424 may be disabled and testing may be performed to determine the minimum number of VMIDN generators needed for light modulator functionality. Such metal layer revisions are faster and less costly than full mask revisions and may be useful for testing. However, in other examples, any number of VMIDN generators 424 may be disabled using switches or other components of the testing circuitry 412.

After testing, the design of a light modulator chip may be optimized to include the number of VMIDN generators 424 needed to support functionality. In some examples, such optimization may involve a full mask revision of a light modulator chip based on test results, where the updated design minimizes power consumption and area (e.g., by eliminating some VMIDN generators 424 that were identified during testing to be excessive). Thus, in an optimized design after testing, some reset blocks 414 may omit the VMIDN generator 424, as described above. In other examples, in an optimized design after testing, certain VMIDN generators 424 that are not needed to meet the current levels to support functionality of the light modulator 110 can be disabled (e.g., disconnected from the signal bus using switches or other components of the testing circuitry 412 or by modifying certain ones of the optional metal interconnects in the testing circuitry 412 via metal layer revisions as described above).

FIG. 6 is a flow diagram of a method 600 of designing or configuring the adjustable reset control circuitry 406 to support pixel performance while reducing (e.g., minimizing) power consumption and/or other parameters.

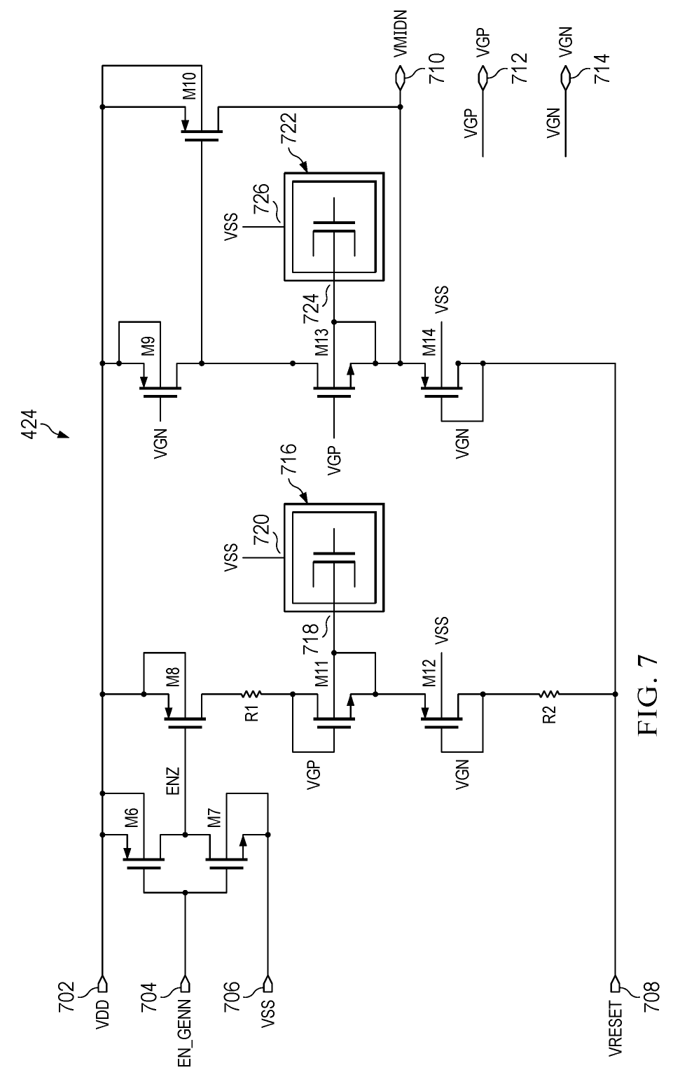

At operation 602, the adjustable reset control circuitry 406 may be provided having an initial or nominal configuration designed to support a wide pixel solution space. For example, some or all reset blocks 414 may include VMIDN generators 424. Furthermore, circuitry such as the set of level shifters 418 and the MBRST drivers 504 may be configured to support a relatively wide voltage range (e.g., reset voltage and/or supply voltage (VDD) supplied to the VMIDN generators 424, as described below with reference to FIG. 7) and/or relatively wide range of control signal timing and/or data slew rates.

At operation 604, operation of the light modulator 110 can be tested with the nominal configuration of the adjustable reset control circuitry 406. Testing may include sweeping the various voltages, signal timing, and/or data slew rates through a range of levels/values to determine thresholds at which the light modulator 110 no longer operates within specified performance parameters. In some examples, testing of the VMIDN generators 424 may include lowering the reset voltage (VRESET; see FIG. 7) and performing a test that asserts VRESET for all pixels 214 of the mirror array 314 at the same time to determine a maximum current draw. The results of this test may be a way to determine a suitable number of VMIDN generators 424.

At operation 606, based on results of the testing performed at operation 604, the configuration of the adjustable reset control circuitry 406 can be adjusted for a narrowed pixel solution space (e.g., testing may reveal narrow voltage ranges, signal timing, and/or data slew rate ranges that support proper functioning of the light modulator 110). For example, certain VMIDN generators 424 may be disabled, as described above. In some examples, operation 608 may involve modification of metal-only layers (e.g., metal layers 206 and/or 208) to selectively disable some of the available VMIDN generators 424 to determine minimum voltage levels and/or minimum current levels.

At operation 608, the light modulator 110 may be retested with the updated configuration of the adjustable reset control circuitry 406 implemented at operation 606.

If needed, operations 606 and 608 can be iteratively repeated until an optimized configuration (e.g., minimum number of functional VMIDN generators 424) is determined.

At operation 610, an optimized configuration of the adjustable reset control circuitry 406 may be selected for the final design and/or implementation of the light modulator 110. In some examples, the light modulator 110 may be configured and/or fabricated based on the optimized configuration selected at operation 610.

FIG. 7 is a schematic diagram of the VMIDN generator 424, according to an example. The VMIDN generator 424 generates an output voltage, VMIDN. In the example of FIG. 7, the VMIDN generator 424 has a first terminal 702, a second terminal 704, a third terminal 706, a fourth terminal 708, a fifth terminal 710, a sixth terminal 712, and a seventh terminal 714. Further, the VMIDN generator 424 includes transistors M6 to M14, resistors R1 and R2, an isolation well 716 for the transistor M11, and an isolation well 722 for the transistor M13. As described further below, the isolation wells 716, 722 may be configured for light blocking to prevent (or reduce) stray photo-carriers from disrupting operation of the transistors M11 and M13. Each of the transistors M6 to M14 has a respective first terminal, a respective second terminal, a respective body terminal, and a respective control terminal. In the example of FIG. 7, the transistors M6, M8, M9, M10, M12, and M14 are PMOS transistors, and the transistors M7, M11, and M13 are NMOS transistors. However, in other examples, other transistor types can be used. The isolation well 716 has a first terminal 718 and a second terminal 720. The isolation well 722 has a first terminal 724 and a second terminal 726.

In the example of FIG. 7, the first terminal and the body terminal of the transistor M6 are coupled to the first terminal 702 of the VMIDN generator 424. The second terminal of the transistor M6 is coupled to the first terminal of the transistor M7 and the control terminal of the transistor M8. The control terminals of the transistors M6 and M7 are coupled to the second terminal 704 of the VMIDN generator 424. The second terminal and the body terminal of the transistor M7 are coupled to the third terminal 706 of the VMIDN generator 424. The first terminal and the body terminal of the transistor M8 are coupled to the first terminal 602 of the voltage regulation circuit 600. The second terminal of the transistor M8 is coupled to the first terminal of the resistor R1. The second terminal of the resistor R1 is coupled to the first terminal and the control terminal of the transistor M11. The control terminal of the transistor M11 is also coupled to the sixth terminal 712 of the VMIDN generator 424. The second terminal and the body terminal of the transistor M11 are coupled to the first terminal of the transistor M12 and the first terminal 718 of the isolation well 716. The second terminal 720 of the isolation well 716 is coupled to the third terminal 706 of the VMIDN generator 424. The control terminal of the transistor M12 is coupled to the seventh terminal 714 of the VMIDN generator 424. The body terminal of the transistor M12 is coupled to the third terminal 706 of the VMIDN generator 424. The second terminal of the transistor M12 is coupled to the first terminal of the resistor R2 and the control terminal of the transistor M12. The second terminal of the resistor R2 is coupled to the fourth terminal 708 of the VMIDN generator 424.

Continuing with the example of FIG. 7, the first terminal and the body terminal of the transistor M9 are coupled to the first terminal 702 of the VMIDN generator 424. The second terminal of the transistor M9 is coupled to the first terminal of the transistor M13 and the control terminal of the transistor M10. The control terminal of the transistor M9 is coupled to the sixth terminal 712 of the VMIDN generator 424. The second terminal and the body terminal of the transistor M13 are coupled to the first terminal of the transistor M14 and the first terminal 724 of the isolation well 722. The second terminal 726 of the isolation well 722 is coupled to the third terminal 706 of the VMIDN generator 424. The control terminal of the transistor M13 is coupled to the sixth terminal 712 of the VMIDN generator 424. The second terminal and the control terminal of the transistor M14 are coupled to the fourth terminal 708 of the VMIDN generator 424. The body terminal of the transistor M14 is coupled to the third terminal 706 of the VMIDN generator 424. The first terminal and the body terminal of the transistor M10 are coupled to the first terminal 702 of the VMIDN generator 424. The second terminal of the transistor M10 is coupled to the fifth terminal 710 of the VMIDN generator 424.

In the example of FIG. 7, the VMIDN generator 424 is configured to: receive VDD at the first terminal 702; receive an enable signal (EN_GENN) at the second terminal 704; receive VRESET at the fourth terminal 708; receive a p-channel gate voltage (VGP) at the sixth terminal 712; receive an n-channel gate voltage (VGN) at the seventh terminal 714; and provide the VMIDN voltage at the fifth terminal 710 responsive to VDD, EN_GENN, VGP, VGN, and VRESET. With the circuit of FIG. 7, current of each VMIDN generator can be reduced compared to other voltage regulation circuits. One way to reduce current for each VMIDN generator is by reducing the size of transistors such as the transistor M8. In some examples, the VMIDN generator 424 of FIG. 7 reduces current for VRESET by approximately 50%, which is suitable for example pixels that have a pixel size which may be less than five µm, for example about 4.5 µm, as described above.

As described above, in certain examples, the light modulator 110, and in particular the adjustable reset control circuitry 406, may include a light blocking apparatus to protect the circuitry from light-induced stray carriers (e.g., photo-carriers) that could otherwise cause glitches and disrupt proper performance of the circuitry. Some applications of the light modulator 110 involve the illumination light 112 having a relatively high intensity (e.g., high lumen value), for example, to allow the light modulator 110 to project high-brightness images 114. However, this high intensity illumination light 112 (e.g., having an intensity above a certain threshold lumen level), which may induce stray carriers, is incident on the circuitry of the light modulator 110 while the circuitry is in operation. Accordingly, a light-blocking apparatus can be provided to protect circuitry that may be sensitive to such stray carriers.

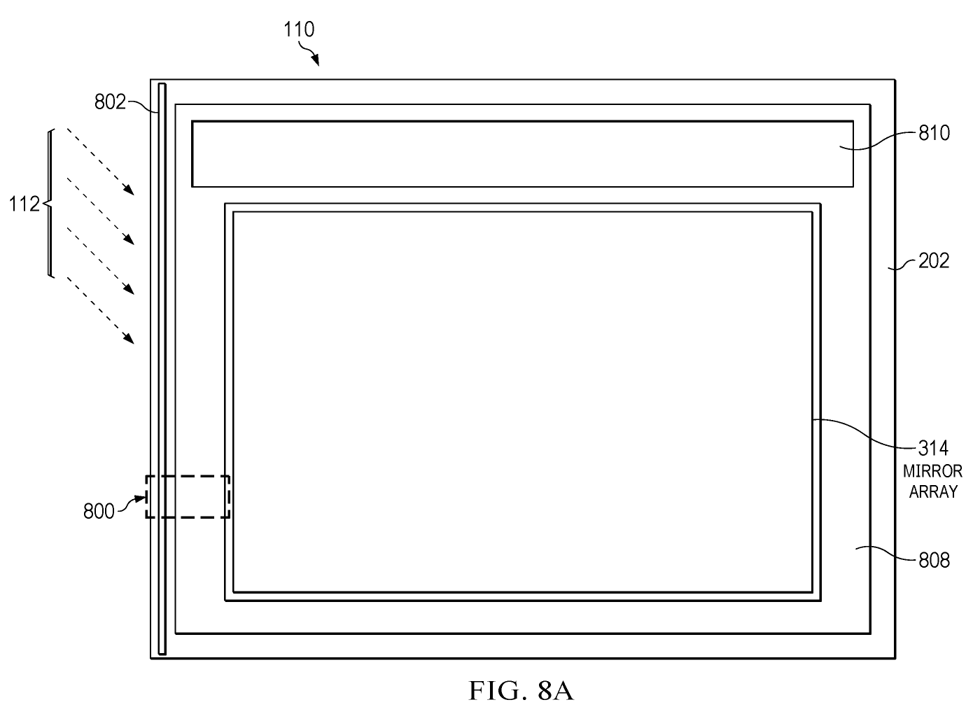

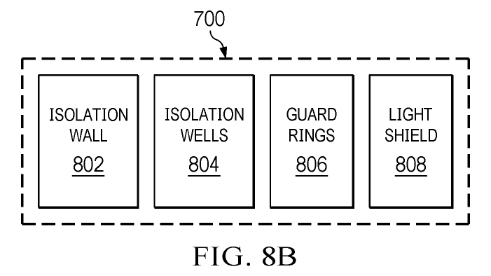

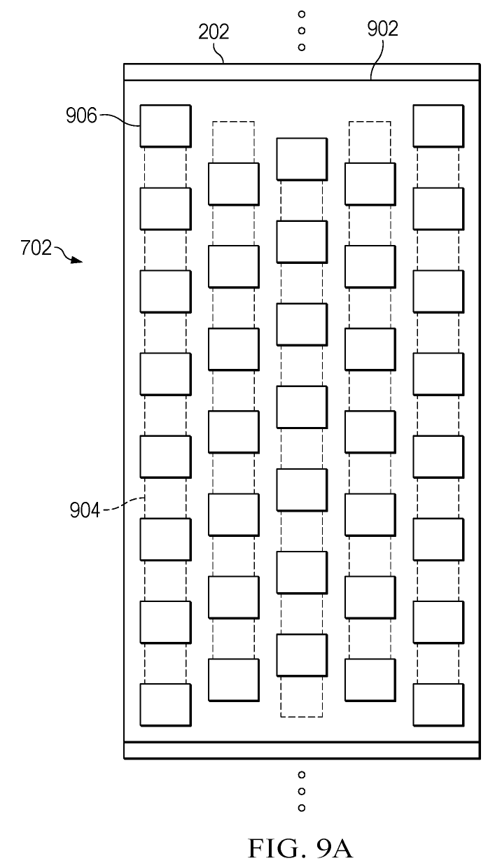

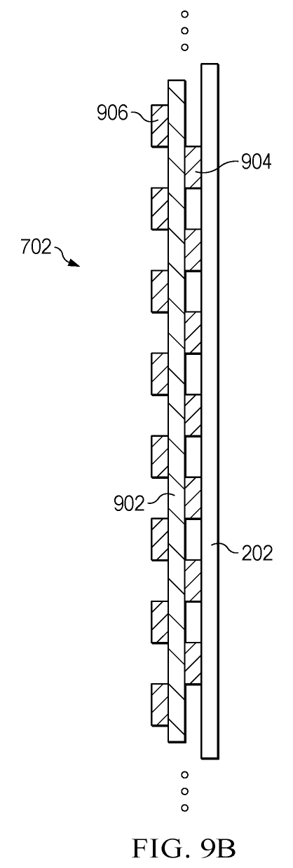

FIG. 8A is a block diagram showing the light modulator 110 including a light-blocking apparatus, according to an example. FIG. 8B is a block diagram showing a representation of a cross-sectional view of a portion 800 of a light-blocking apparatus, according to an example. The light-blocking apparatus may include at least one isolation wall 802, one or more isolation wells 804, one or more guard rings 806, and a light shield 808. In some examples, the isolation wall(s) 802 are formed various layers of the layered structure (e.g., shown in FIG. 2) of the light modulator 110, as described further below with reference to FIGS. 9A and 9B. As illustrated in FIG. 8A, the isolation wall(s) 802 may be placed in areas where high lumens from the illumination beam 112 are likely to reach silicon layer(s) of the light modulator 110. The isolation wall(s) 802 may be configured to encourage recombination of stray carriers within the substrate 202 and/or other layers of the light modulator 110 prior to travelling to areas where sensitive circuitry (such as components of the level shifters 418, voltage generators 424, MBRST drivers 504, or memory cells 302, for example) is located.

FIG. 9A is a diagram illustrating a top view of a portion of the isolation wall 802, according to an example FIG. 9B is a corresponding diagrammatic cross-sectional view of the portion of the isolation wall 802. In some examples, the isolation wall 802 includes an arrangement of metal structures and vias formed in multiple layers of the light modulator 110 structure on the substrate 202. For example, as shown in FIGS. 9A and 9B, the isolation wall 802 may include a first region 902 formed in at least one first metal layer of the metal layers 206 and/or 208, and first pattern of metal vias 904 formed in at least one second metal layer of the metal layer 206 and/or 208 and electrically connected to the first region 902. The isolation wall 802 may further include a second pattern of metal structures 906 formed in at least one third metal layer of the metal layers 206 and/or 208. As shown, the first region 902 may be positioned between the first pattern of metal structures 906. The metal layers in which the first region 902, the first pattern of metal vias 904, and the second pattern of metal structures 906 are formed may be sub-layers of any one or more of the metal layers 206 and/or 208 described above or additional metal layers not explicitly shown in FIG. 2. In some examples, the second pattern of metal structures 906 is spatially offset from the first pattern of metal vias 904 such that the metal structures 906 are at least partially non-overlapping with the metal vias 904. The structure of the isolation wall (with the staggered metal vias 904 and structures 906) may be operable to block stray carriers from passing through the isolation wall 802 towards circuitry of the light modulator 110 and to encourage recombination of the stray carriers within the structure. FIGS. 9A and 9B are not drawn to scale and do not necessarily represent all layers used in formation of the isolation wall 802.

Referring again to FIGS. 8A and 8B, as described above, the light-blocking apparatus may include one or more guard rings 806 and isolation wells 804 that can be positioned around circuitry of the light modulator 110 that may be sensitive to the effects of stray carriers. These guard rings 806 and isolation wells 804 may further encourage recombination of stray carriers before they can affect the operation of carrier-sensitive circuitry. The guard rings 804 may be formed in any one or more metal layers (e.g., metal layers 206, 208, and/or other layers or sub-layers) of the light modulator 110. As described above, one or more of the metal layers 206, 208 may be used to form metal interconnects (e.g., conductive patterns) that can be used to route electrical signals to and from adjacent layers. In some examples, at least a portion of these metal interconnects can be used to provide the light shield 808 that may be positioned over certain carrier-sensitive circuitry (e.g., transistors of the level shifters 418, voltage generators 424, MBRST drivers 504, and/or memory cells 302) to further prevent the incident light 112 from producing local stray carriers in the vicinity of the carrier-sensitive circuitry. As shown in FIG. 8A, in some examples, the light shield 808 may include one or more openings 810, preferably positioned over less sensitive circuitry, as may be needed to route signals (e.g., electrical, RF, and/or optical signals) to and from the light modulator 110.

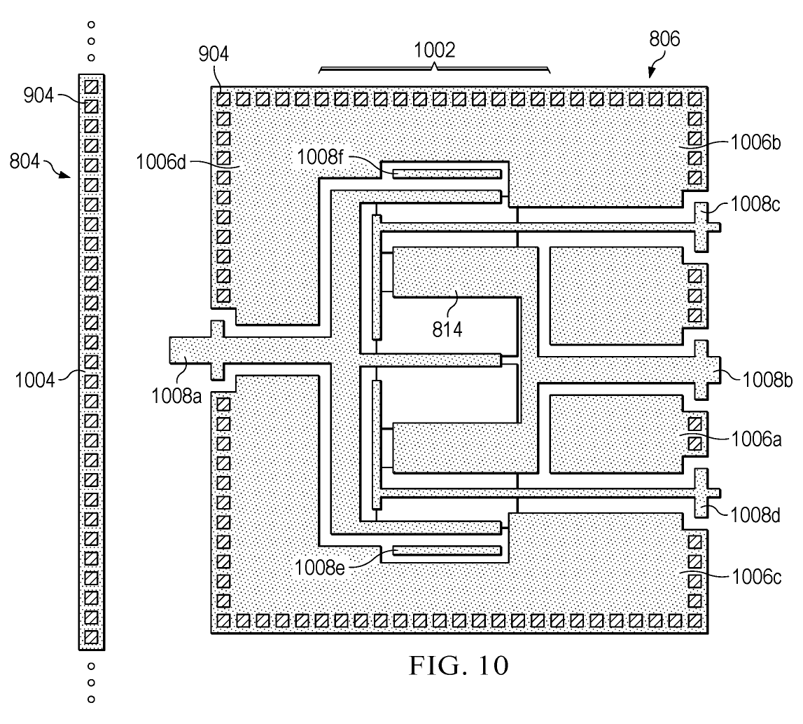

Referring to FIG. 10, there is illustrated a diagram showing an example of interconnect metal used to form a portion of the light shield 808, an isolation well 804, and a guard ring 806 positioned about a transistor 1002. As shown, the isolation well 804 may include a plurality of vias 904 electrically coupled to a metal region 1004. In some examples, the isolation well 804 may have a cross-sectional structure similar to that of the isolation wall 802 shown in FIG. 9B. The isolation well 1002 may be an example of the isolation wells 716 and/or 722 used in the VMIDN generator 424. The transistor 1002 may be representative of any transistor used in the circuitry described herein, including (but not limited to) the transistors M11 and M13 of the VMIDN generator 424. As shown in FIG. 10, the guard ring 806 at least partially surrounds the transistor 806. The guard ring 806 includes a plurality of vias 904 and metal regions 1006a-d that are electrically connected to the vias 904. The metal interconnects forming part of the light shield 808 include metal regions 1008a-f that are not electrically connected to the vias 904. In some examples, all metal regions 1004, 1006a-d, and 1008a-f are formed in the same metal layer (e.g., one of the metal layers 206, 208, or another layer), thus improving overall light blocking efficiency.

Thus, aspects and examples provide techniques and circuitry to improve efficiency and performance in control circuitry for light modulators that is compatible with smaller pixel sizes (e.g., less than 5 µm) and optional diamond array patterns.

### Conclusion

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Also, in this description, the recitation “based on” means “based at least in part on.” Therefore, if X is based on Y, then X may be a function of Y and any number of other factors.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

As used herein, the terms “terminal,” “node,” “interconnection,” “pin,” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples may be included in an integrated circuit and other elements may be external to the integrated circuit, in other examples, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

In this description, unless otherwise stated, “about,” “approximately” or “substantially” preceding a parameter means being within +/- 10 percent of that parameter or, if the parameter is zero, a reasonable range of values around zero.

In the foregoing descriptions, for purposes of explanation, numerous specific details are set forth to provide a thorough understanding of one or more examples. However, this disclosure may be practiced without some or all these specific details, as will be evident to one having ordinary skill in the art. In other instances, well-known process steps or structures have not been described in detail in order not to unnecessarily obscure this disclosure. In addition, while the disclosure is described in conjunction with example examples, this description is not intended to limit the disclosure to the described examples. To the contrary, the description is intended to cover alternatives, modifications, and equivalents as may be included within the spirit and scope of the disclosure as defined by the appended claims.

### Further Examples

Example 1 is a light modulator comprising: a two-dimensional array of pixel elements grouped into blocks, individual blocks including one or more pixel elements of the array, the pixel elements arranged relative to one another in the array with at least a minimum pixel pitch and having operating states configurable between an ON state and an OFF state; and reset control circuitry coupled to the array of pixel elements and configurable to control the operating states of the pixel elements. The reset control circuitry includes: a plurality of banks of pixel block drivers configurable to output respective reset voltages for respective individual blocks, and each bank of pixel block drivers in the plurality of banks of pixel block drivers including a bank of reset capacitors and one or more reset drivers arranged according to the minimum pixel pitch; a signal bus coupled to the plurality of banks of pixel block drivers; and one or more supply voltage generators selectively couplable to the signal bus and configurable to generate a supply voltage for one or more of the banks of pixel block drivers. The light modulator further comprises a light-blocking apparatus configured to protect one or more elements of the reset control circuitry from stray carriers induced by light incident on the light modulator with an intensity above a threshold lumen level.

Example 2 includes the light modulator of Example 1, wherein the reset control circuitry further comprises, for each respective bank of pixel block drivers in the plurality of banks of pixel block drivers: at least one level shifter; and at least one buffer; wherein the at least one level shifter and the at least one buffer are electrically connected between the signal bus and the respective bank of pixel block drivers.

Example 3 includes the light modulator of one of Examples 1 or 2, further comprising: a substrate; and one or more metal layers stacked on the substrate between the substrate and the array of pixel elements; wherein the reset circuitry and the light-blocking apparatus are at least partially formed in the one or more metal layers.

Example 4 includes the light modulator of Example 3, wherein each supply voltage generator of the one or more supply voltage generators comprises a plurality of transistors coupled to first and second supply terminals and to an output terminal at which the supply voltage is produced; and wherein the light-blocking apparatus comprises at least one isolation well coupled to a corresponding at least one transistor of the plurality of transistors.

Example 5 includes the light modulator of Example 4, wherein: the one or more metal layers include at least a first metal layer and a second metal layer spatially separated from one another and electrically coupled together by a plurality of metal vias; the light-blocking apparatus includes a guard ring formed in the first metal layer and at least partially surrounding the at least one transistor in the first metal layer, the guard ring coupled to at least some of the plurality of metal vias; and the at least one transistor includes interconnection circuitry formed in the first metal layer and electrically isolated from the plurality of vias.

Example 6 includes the light modulator of any one of Examples 3-5, wherein the one or more metal layers include a plurality of metal layers; and wherein the light-blocking apparatus includes an isolation wall formed in the plurality of metal layers, the isolation wall including: a first region formed in a first metal layer of the plurality of metal layers, a first pattern of metal vias formed in a second metal layer and electrically connected to the first metal layer; and a second pattern of metal structures formed in a third metal layer, the first metal layer positioned between the second and third metal layers, the second pattern of metal structures being spatially offset from the first pattern of metal vias such that the metal structures are at least partially non-overlapping with the metal vias.

Example 7 includes the light modulator of any one of Examples 3-6, wherein the reset circuitry includes a plurality of metal interconnects formed in at least one of the one or more metal layers and configurable to selectively couple the one or more supply voltage generators to the signal bus.

Example 8 includes the light modulator of any one of Examples 3-7, further comprising: a two-dimensional array of memory cells on the substrate; wherein individual pixel elements are electrically connected to an output of a respective memory cell of the array of memory cells; and wherein the memory cells are static random access memory cells.

Example 9 includes the light modulator of Example 8, wherein each memory cell includes five transistors.

Example 10 includes the light modulator of one of Examples 8 or 9, wherein there is a one-to-one ratio of a number of memory cells in the array of memory cells and a number of pixels elements in the array of array of pixels elements.

Example 11 includes the light modulator of any one of Examples 8-10, wherein the array of memory cells is in a grid pattern, and wherein the array of pixel elements is in a diamond pattern that is oriented at an angle relative to the grid pattern of the array of memory cells, each pixel element of the array of pixel elements overlapping respective portions of at least two memory cells of the array of memory cells, each pixel element of the array of pixel elements electrically connected to an output of a respective memory cell of the array of memory cells.

Example 12 includes the light modulator of Example 11, wherein each pixel element of the array of pixel elements shares, with a respective adjacent pixel element of the array of pixel elements, an electrical connection to a block step address (BSA).

Example 13 includes the light modulator of one of Examples 1-12, wherein each pixel element of the array of pixel elements includes a micromirror.

Example 14 includes the light modulator of any one of Example 1-13, wherein the minimum pixel pitch is in a range of two to five micrometers.

Example 15 is an integrated circuit comprising: a substrate; a two-dimensional array of memory cells on the substrate; a two-dimensional array of pixel elements positioned over the array of memory cells, each pixel element of the array of pixel elements electrically connected to an output of a respective memory cell of the array of memory cells; a plurality of metal layers arranged between the array of memory cells and the array of pixel elements; control circuitry including circuit elements formed in one or more metal layers of the plurality of metal layers, the circuit elements including at least one transistor and the control circuitry operably coupled to the array of memory cells; and a light-blocking apparatus. The light blocking apparatus includes: one or more guard rings formed in the one or more metal layers and at least partially surrounding a corresponding one or more respective circuit elements in the one or more metal layers; at least one isolation well coupled to the at least one transistor; and an isolation wall operable to block stray carriers from reaching the circuit elements, the stray carriers being induced by light incident on the integrated circuit with an intensity above a threshold lumen level.

Example 16 includes the integrated circuit of Example 15, wherein the isolation wall comprises: a first region formed in a first metal layer of the plurality of metal layers, a first pattern of metal vias formed in a second metal layer and electrically connected to the first metal layer; and a second pattern of metal structures formed in a third metal layer, the first metal layer positioned between the second and third metal layers, the second pattern of metal structures being spatially offset from the first pattern of metal vias such that the metal structures are at least partially non-overlapping with the metal vias.

Example 17 includes the integrated circuit of Example 16, wherein: the one or more metal layers include at least a first metal layer and a second metal layer spatially separated from one another and electrically coupled together by a plurality of metal vias; the at least one transistor includes interconnection circuitry formed in the first metal layer and electrically isolated from the plurality of vias; and the one or more guard rings include a guard ring formed in the first metal layer and at least partially surrounding the at least one transistor in the first metal layer, the guard ring coupled to at least some of the plurality of metal vias.

Example 18 includes the integrated circuit of any one of Examples 16-18, wherein the control circuitry includes a supply voltage generator that includes the at least one transistor.

Example 19 includes the integrated circuit of Example 18, wherein the supply voltage generator is a first supply voltage generator and the control circuitry further includes: a plurality of banks of pixel block drivers configurable to output respective voltages for respective individual blocks of the pixel elements, each bank of pixel block drivers in the plurality of banks of pixel block drivers including a bank of reset capacitors and one or more reset drivers; a signal bus coupled to the plurality of banks of pixel block drivers; and a second supply voltage generator that can be selectively coupled to the signal bus; wherein the first supply voltage generator is coupled to the signal bus and configurable to generate a supply voltage for one or more of the banks of pixel block drivers.

Example 20 includes the integrated circuit of Example 19, wherein the control circuitry further includes one or more metal interconnects formed in at least one of the one or more metal layers and configurable to selectively couple the second supply voltage generator to the signal bus; wherein the second supply voltage generator is selectively coupled to the signal bus based on a supply current demand of the control circuitry.

Example 21 is a light modulator including the integrated circuit of any one of Examples 15-20.

Example 22 is a light modulator comprising: a substrate; a two-dimensional array of memory cells on the substrate; a two-dimensional array of pixel elements positioned over the array of memory cells, each pixel element of the array of pixel elements electrically connected to an output of a respective memory cell of the array of memory cells, the array of pixel elements arranged into a plurality of groups with each group including one or more pixel elements; and control circuitry coupled to the array of memory cells and to the array of pixel elements. The control circuitry includes: a data interface configurable to receive image data, the control circuitry configurable to write the image data to the array of memory cells to control operational states of the array of pixel elements, and adjustable reset control circuitry including: a plurality of banks of pixel block drivers configurable to provide respective control voltages to respective individual groups and each bank of pixel block drivers in the plurality of banks of pixel block drivers including a bank of reset capacitors and an adjustable number of one or more reset drivers; a signal bus coupled to the plurality of banks of pixel block drivers; an adjustable number of supply voltage generators selectively coupled to the signal bus and configurable to provide a supply voltage to the signal bus; a plurality of level shifters coupled between the signal bus and the plurality of banks of pixel block drivers, individual level shifters configurable to adjust a voltage level of the supply voltage supplied to a respective one of the plurality of banks of pixel block drivers; and a plurality of buffers coupled between the plurality of level shifters and the plurality of banks of pixel block drivers.

Example 23 includes the light modulator of Example 22, wherein each supply voltage generator in the adjustable number of supply voltage generators comprises: a plurality of transistors coupled to first and second supply terminals and to an output terminal at which the supply voltage is produced; at least one isolation well coupled to a corresponding at least one transistor of the plurality of transistors; and at least one guard ring at least partially surrounding the at least one transistor; wherein the light modulator includes at least a first metal layer and a second metal layer positioned between the array of memory cells and the array of pixel elements, the first and second metal layers electrically coupled together by a plurality of metal vias; wherein the at least one transistor includes interconnection circuitry formed in the first metal layer and electrically isolated from the plurality of vias; and wherein the at least one guard ring is formed in the first metal layer and is electrically coupled to at least some of the plurality of metal vias.

Modifications are possible in the described examples, and other examples are possible within the scope of the claims.

1. A light modulator comprising:
a two-dimensional array of pixel elements grouped into blocks, individual blocks including one or more pixel elements of the array, the pixel elements arranged relative to one another in the array with at least a minimum pixel pitch and having operating states configurable between an ON state and an OFF state;
reset control circuitry coupled to the array of pixel elements and configurable to control the operating states of the pixel elements, the reset control circuitry including
a plurality of banks of pixel block drivers configurable to output respective reset voltages for respective individual blocks, and each bank of pixel block drivers in the plurality of banks of pixel block drivers including a bank of reset capacitors and one or more reset drivers arranged according to the minimum pixel pitch,
a signal bus coupled to the plurality of banks of pixel block drivers, and
one or more supply voltage generators selectively couplable to the signal bus and configurable to generate a supply voltage for one or more of the banks of pixel block drivers; and
a light-blocking apparatus configured to protect one or more elements of the reset control circuitry from stray carriers induced by light incident on the light modulator with an intensity above a threshold lumen level.

2. The light modulator of claim 1, wherein the reset control circuitry further comprises, for each respective bank of pixel block drivers in the plurality of banks of pixel block drivers:
at least one level shifter; and
at least one buffer;
wherein the at least one level shifter and the at least one buffer are electrically connected between the signal bus and the respective bank of pixel block drivers.

3. The light modulator of claim 1, further comprising:
a substrate; and
one or more metal layers stacked on the substrate between the substrate and the array of pixel elements;
wherein the reset control circuitry and the light-blocking apparatus are at least partially formed in the one or more metal layers.

4. The light modulator of claim 3, wherein each supply voltage generator of the one or more supply voltage generators comprises a plurality of transistors coupled to first and second supply terminals and to an output terminal at which the supply voltage is produced; and
wherein the light-blocking apparatus comprises at least one isolation well coupled to a corresponding at least one transistor of the plurality of transistors.

5. The light modulator of claim 4, wherein:
the one or more metal layers include at least a first metal layer and a second metal layer spatially separated from one another and electrically coupled together by a plurality of metal vias;
the light-blocking apparatus includes a guard ring formed in the first metal layer and at least partially surrounding the at least one transistor in the first metal layer, the guard ring coupled to at least some of the plurality of metal vias; and
the at least one transistor includes interconnection circuitry formed in the first metal layer and electrically isolated from the plurality of metal vias.

6. The light modulator of claim 3, wherein the one or more metal layers include a plurality of metal layers; and
wherein the light-blocking apparatus includes an isolation wall formed in the plurality of metal layers, the isolation wall including:
a first region formed in a first metal layer of the plurality of metal layers,
a first pattern of metal vias formed in a second metal layer and electrically connected to the first metal layer; and
a second pattern of metal structures formed in a third metal layer, the first metal layer positioned between the second and third metal layers, the second pattern of metal structures being spatially offset from the first pattern of metal vias such that the metal structures are at least partially non-overlapping with the metal vias.

7. The light modulator of claim 3, wherein the reset control circuitry includes a plurality of metal interconnects formed in at least one of the one or more metal layers and configurable to selectively couple the one or more supply voltage generators to the signal bus.

8. The light modulator of claim 3, further comprising:
a two-dimensional array of memory cells on the substrate;
wherein individual pixel elements are electrically connected to an output of a respective memory cell of the array of memory cells; and
wherein the memory cells are static random access memory cells.

9. The light modulator of claim 8, wherein there is a one-to-one ratio of a number of memory cells in the array of memory cells and a number of pixels elements in the array of array of pixels elements.

10. The light modulator of claim 1, wherein the minimum pixel pitch is in a range of two to five micrometers.

11. The light modulator of claim 1, wherein each pixel element of the array of pixel elements includes a micromirror.

12. The light modulator of claim 11, wherein each micromirror is tiltable to selectively direct light in different directions.

13. An integrated circuit comprising:
a substrate;
a two-dimensional array of memory cells on the substrate;
a two-dimensional array of pixel elements positioned over the array of memory cells, each pixel element of the array of pixel elements electrically connected to an output of a respective memory cell of the array of memory cells;
a plurality of metal layers arranged between the array of memory cells and the array of pixel elements;
control circuitry including circuit elements formed in one or more metal layers of the plurality of metal layers, the circuit elements including at least one transistor and the control circuitry operably coupled to the array of memory cells; and
a light-blocking apparatus including
one or more guard rings formed in the one or more metal layers and at least partially surrounding a corresponding one or more respective circuit elements in the one or more metal layers,
at least one isolation well coupled to the at least one transistor, and
an isolation wall operable to block stray carriers from reaching the circuit elements, the stray carriers being induced by light incident on the integrated circuit with an intensity above a threshold lumen level.

14. The integrated circuit of claim 13, wherein the isolation wall comprises:
a first region formed in a first metal layer of the plurality of metal layers,
a first pattern of metal vias formed in a second metal layer and electrically connected to the first metal layer; and
a second pattern of metal structures formed in a third metal layer, the first metal layer positioned between the second and third metal layers, the second pattern of metal structures being spatially offset from the first pattern of metal vias such that the metal structures are at least partially non-overlapping with the metal vias.

15. The integrated circuit of claim 13, wherein:
the one or more metal layers include at least a first metal layer and a second metal layer spatially separated from one another and electrically coupled together by a plurality of metal vias;
the at least one transistor includes interconnection circuitry formed in the first metal layer and electrically isolated from the plurality of metal vias; and
the one or more guard rings include a guard ring formed in the first metal layer and at least partially surrounding the at least one transistor in the first metal layer, the guard ring coupled to at least some of the plurality of metal vias.

16. The integrated circuit of claim 13, wherein the control circuitry includes a supply voltage generator that includes the at least one transistor.

17. The integrated circuit of claim 16, wherein the supply voltage generator is a first supply voltage generator and the control circuitry further includes:
a plurality of banks of pixel block drivers configurable to output respective voltages for respective individual blocks of the pixel elements, each bank of pixel block drivers in the plurality of banks of pixel block drivers including a bank of reset capacitors and one or more reset drivers;
a signal bus coupled to the plurality of banks of pixel block drivers; and
a second supply voltage generator that can be selectively coupled to the signal bus;
wherein the first supply voltage generator is coupled to the signal bus and configurable to generate a supply voltage for one or more of the banks of pixel block drivers.

18. The integrated circuit of claim 17, wherein the control circuitry further includes one or more metal interconnects formed in at least one of the one or more metal layers and configurable to selectively couple the second supply voltage generator to the signal bus;
wherein the second supply voltage generator is selectively coupled to the signal bus based on a supply current demand of the control circuitry.

19. A light modulator comprising:
a substrate;
a two-dimensional array of memory cells on the substrate;
a two-dimensional array of pixel elements positioned over the array of memory cells, each pixel element of the array of pixel elements electrically connected to an output of a respective memory cell of the array of memory cells, the array of pixel elements arranged into a plurality of groups with each group including one or more pixel elements; and
control circuitry coupled to the array of memory cells and to the array of pixel elements, the control circuitry including
a data interface configurable to receive image data, the control circuitry configurable to write the image data to the array of memory cells to control operational states of the array of pixel elements, and
adjustable reset control circuitry including
a plurality of banks of pixel block drivers configurable to provide respective control voltages to respective individual groups and each bank of pixel block drivers in the plurality of banks of pixel block drivers including a bank of reset capacitors and an adjustable number of one or more reset drivers,
a signal bus coupled to the plurality of banks of pixel block drivers,
an adjustable number of supply voltage generators selectively coupled to the signal bus and configurable to provide a supply voltage to the signal bus,
a plurality of level shifters coupled between the signal bus and the plurality of banks of pixel block drivers, individual level shifters configurable to adjust a voltage level of the supply voltage supplied to a respective one of the plurality of banks of pixel block drivers, and
a plurality of buffers coupled between the plurality of level shifters and the plurality of banks of pixel block drivers.

20. The light modulator of claim 19, wherein each supply voltage generator in the adjustable number of supply voltage generators comprises:
a plurality of transistors coupled to first and second supply terminals and to an output terminal at which the supply voltage is produced;
at least one isolation well coupled to a corresponding at least one transistor of the plurality of transistors; and
at least one guard ring at least partially surrounding the at least one transistor;
wherein the light modulator includes at least a first metal layer and a second metal layer positioned between the array of memory cells and the array of pixel elements, the first and second metal layers electrically coupled together by a plurality of metal vias;
wherein the at least one transistor includes interconnection circuitry formed in the first metal layer and electrically isolated from the plurality of metal vias; and
wherein the at least one guard ring is formed in the first metal layer and is electrically coupled to at least some of the plurality of metal vias.
